(19) United States
(12) Patent Application Publication
(10) Pub. No.: US 2026/0363506 A1
(43) Pub. Date: Nov. 19, 2026

(54) HANDHELD BLOWER APPARATUS HAVING A BLOWER TUBE

(71) Applicant: Andreas Stihl AG & Co. KG, Waiblingen (DE)

(72) Inventors: Johannes Bosch, Fremdingen (DE); Sebastian Junker, Ludwigsburg (DE); Simon Frey, Iggingen (DE); Dennis Karl, Schwaigern (DE); Felix Oberhofer, Stuttgart (DE); Leon Sieder, Remshalden (DE)

(21) Appl. No.: 19/676,660

(22) Filed: May 13, 2026

(30) Foreign Application Priority Data
May 15, 2025 (DE) 10 2025 118 935.8

(51) Int. Cl. A47L 9/08; A47L 5/14; A47L 9/24; F04D 25/06; F04D 29/32

(52) U.S. Cl. CPC A47L 9/08; A47L 5/14; A47L 9/244; A47L 9/248; F04D 25/06; F04D 29/325

(57) ABSTRACT

A handheld blower apparatus has a blower tube and a housing. A drive motor is arranged in the housing, which drive motor drives a fan wheel in a rotating manner. The fan wheel takes in an air flow via an intake opening of the housing and delivers the air flow via a discharge opening of the housing. The blower tube is connected to the discharge opening of the housing. The blower tube is configured as a telescopic tube with at least two tube segments, and having a fixing device. The fixing device includes a locking lever and a holding contour corresponding to the locking lever. The holding contour is arranged at a distal end of the distal tube segment.

### CROSS-REFERENCE TO RELATED APPLICATIONS

This application claims priority of German patent application no. 10 2025 118 935.8, filed May 15, 2025, the entire content of which is incorporated herein by reference.

### BACKGROUND

From the prior art, handheld blower apparatuses are known which are used for blowing away plant material such as foliage, et cetera. Such blower apparatuses include a blower tube and a housing, wherein a drive motor is arranged in the housing. The drive motor drives the fan wheel in a rotating manner. The fan wheel takes in an air flow via an intake opening of the housing and delivers the air flow via a discharge opening of the housing. The blower tube is connected to the discharge opening of the housing. The blower tube is configured as a telescopic tube with two tube segments. The blower tube can thus be retracted and extended, wherein the retracted position of the blower tube is usually provided for stowing, and the extended position of the blower tube is usually provided for the intended operation.

A disadvantage of such blower apparatuses is that the telescoping of the blower tube is sometimes very complicated or the blower tube even moves apart in an undesired manner. Handling of the blower apparatus therefore proves awkward.

### SUMMARY

It is an object of the disclosure to provide a handheld blower apparatus which enables simple handling.

This object is achieved by a handheld blower apparatus according to various embodiments of the disclosure.

According to various embodiments, a handheld blower apparatus includes a blower tube and a housing. A drive motor is arranged in the housing. The drive motor drives a fan wheel in a rotating manner. In the driven state, the fan wheel takes in an air flow via an intake opening of the housing and delivers the air flow via a discharge opening of the housing. The blower tube is connected to the discharge opening of the housing. The blower tube is configured as a telescopic tube with at least two tube segments. Furthermore, the handheld blower apparatus includes a fixing device. The fixing device includes a locking lever and a holding contour corresponding to the locking lever. The holding contour is arranged at the distal end of the distal tube segment.

In the retracted position of the blower tube, the locking lever of the fixing device engages in the holding contour of the distal tube segment. The locking lever engages in the holding contour and reliably secures the blower tube in the retracted position. By actuating the locking lever, the user can release the fixing device and telescope the blower tube into an extended position. The locking lever itself forms a simple and intuitive operating element of the fixing device which, on the one hand, enables intuitive actuation of the fixing device and, on the other hand, enables reliable securing of the blower tube in the retracted position.

By forming the holding contour at the distal end of the distal tube segment, the distal tube segment can be almost fully retracted, as a result of which the blower apparatus is particularly compact in the retracted position of the blower tube.

According to various embodiments, it is provided that the blower tube can be detachably fastened to a tube connector of the blower apparatus. In order to convert the blower apparatus into an even more compact state, the blower tube can be detached from the blower apparatus, as a result of which the blower apparatus and the blower tube can be stowed separately from one another. Furthermore, it is also possible to mount a different blower tube on the blower apparatus.

The fixing device is, according to various embodiments, a constituent part of the blower tube and is configured, in particular, for one-handed operation for retracting and extending the blower tube. This enables the user to hold the blower apparatus with one hand and to actuate the fixing device and telescope the blower tube with the other hand. It is not necessary to put down the blower apparatus, for example on a table, in order to disengage the fixing device with one hand and pull the blower tube apart with the other hand.

According to various embodiments, it is provided that the blower tube includes a plurality of, in particular three, tube segments which are movable relative to one another, wherein the locking lever is arranged on a proximal tube segment. The arrangement of the locking lever on the proximal tube segment and the formation of the holding contour on the distal tube segment means that the blower tube is held in the retracted position via the outer tube segments via the fixing device. In other words, if the blower tube includes three or more tube segments, the tube segments between the outermost tube segments, that is to say between the proximal and the distal tube segment, are held by the outermost tube segments.

According to various embodiments, it is provided that the locking lever is mounted so as to be pivotable about a pivot axis and can be pivoted into a holding position for securing the tube in the retracted position and into a release position for extending the tube. With the actuation of the locking lever, the user pivots the locking lever about a pivot axis. In the process, the locking lever releases the distal tube segment for extension.

According to various embodiments, it is provided that the locking lever includes a spring element, wherein the locking lever is tensioned into the holding position via the spring element and can be pivoted into the release position in opposition to the spring force of the spring element via an actuating portion formed on the locking lever. If the user releases the locking lever again after actuation, the locking lever is returned to its tensioned state again by the spring element. The pretensioning of the locking lever by the spring element has the effect that the locking lever is reliably tensioned into the holding contour and thus reliably holds the blower tube in the retracted position.

The corresponding active surfaces of the locking lever and of the holding contour are arranged obliquely, in particular with respect to the movement direction of the tube segments. The movement direction of the tube segments corresponds to the direction of the longitudinal center axis of the blower tube. This enables the user to apply positive pressure to the locking lever, in particular during retraction of the blower tube. In other words, it is not necessary to actuate the locking lever during retraction of the blower tube. The locking lever is pretensioned into its holding position, wherein the locking lever is pivoted back out of the holding contour in opposition to the spring force as a result of the interaction between the active surfaces of the locking lever and the holding contour during retraction of the blower tube. When the distal tube segment is fully inserted, the locking lever pivots back into the holding contour. This enables the user to retract the blower tube particularly easily.

The holding contour is formed by a circumferential collar of a tube segment, in particular by a groove on a circumferential collar of a tube segment. The collar is formed in particular by a mounting ring. The collar projects beyond all of the tube segments in the radial direction relative to a longitudinal center axis of the blower tube, as a result of which these tube segments are held by the collar during retraction of the distal tube segment and inserted into the proximal tube segment.

According to various embodiments, it is provided that the plurality of tube segments can be fastened to one another via conical surfaces. The fastening of the plurality of tube segments via conical surfaces takes place in an extended state of the blower tube. This ensures that the individual tube segments are also reliably held in the extended position of the blower tube and an inadvertent telescoping, in particular retraction of the blower tube, can be avoided.

It is provided according to various embodiments that, in a fully extended position of the blower tube, the handheld blower apparatus has a first overall length, measured in the direction of a longitudinal center axis of the blower tube, and, in a fully retracted position of the blower tube, a second overall length, measured in the direction of the longitudinal center axis of the blower tube, wherein the second overall length of the blower apparatus corresponds at most to 75%, in particular at most to 70%, of the first overall length of the blower apparatus, wherein, in the retracted position, the blower tube is secured against an extension movement by the fixing device.

As a result, the blower tube is provided with a very high telescopability, which enables the user to convert the blower apparatus with the blower tube into an extremely compact state by retracting the blower tube. This makes it easier for the user to stow the blower apparatus.

### BRIEF DESCRIPTION OF DRAWINGS

The invention will now be described with reference to the drawings wherein:

FIG. 1 shows, in a schematic, perspective illustration, the blower apparatus according to the disclosure with a blower tube in the retracted position;

FIG. 2 shows, in a schematic side illustration, the blower apparatus according to FIG. 1 with a blower tube in the extended position;

FIG. 3 shows, in a schematic side illustration, the blower apparatus according to FIG. 1 with a blower tube in the retracted position;

FIG. 4 shows, in a schematic plan view, the blower apparatus according to FIG. 1 with a blower tube in the retracted position;

FIG. 5 shows, in a schematic, detailed sectional illustration, the blower tube mounted on the tube connector in the extended position;

FIG. 6 shows, in a schematic, detailed sectional illustration according to section line AA in FIG. 4, the blower tube mounted on the tube connector in the retracted position; and,

FIGS. 7-9 show various perspective illustrations of the blower tube in the retracted position.

### DETAILED DESCRIPTION

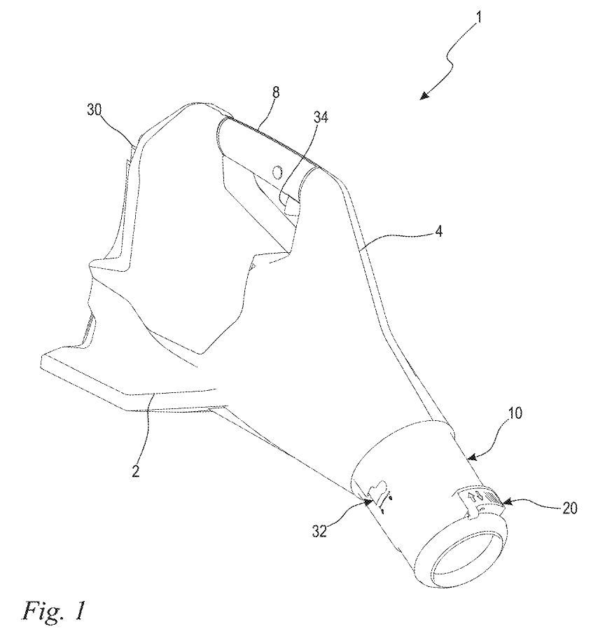

FIG. 1 shows a hand-guided, in particular handheld, blower apparatus 1. The term "handheld" is to be understood in such a way that the blower apparatus 1 is held by the user during its intended operation. The blower apparatus 1 is used, for example, to remove, in particular to blow away, foliage or the like from paths and lawns. The blower apparatus 1 includes a housing 2 and a blower tube 10 arranged on the housing 2. The housing 2 includes a housing base body 4. A handle 8 is formed on the housing base body 4. The handle 8 is used to carry and guide the blower apparatus 1. In an alternative embodiment of the blower apparatus 1, a further handle can also be provided.

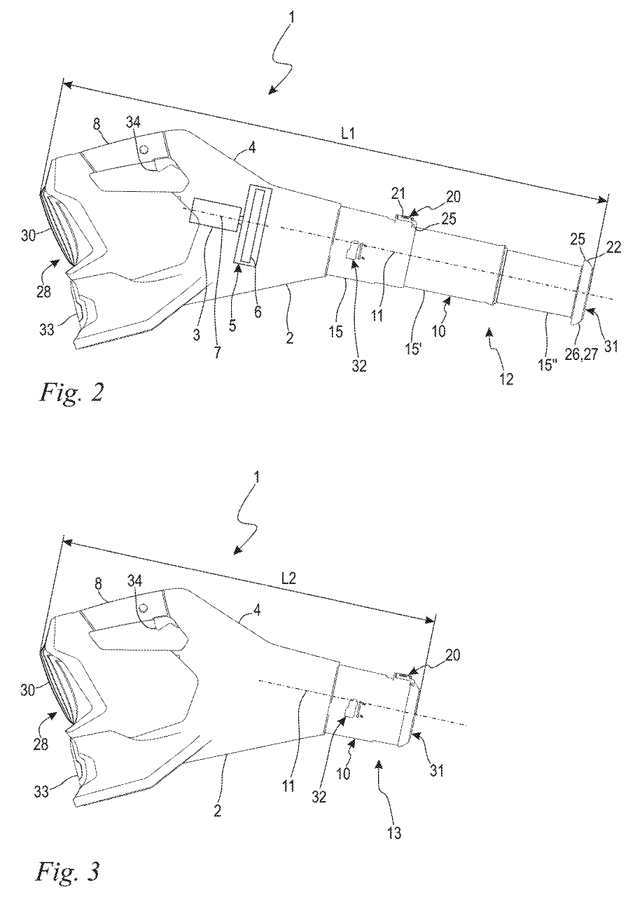

As schematically indicated in FIG. 2, the blower apparatus 1 includes a blower 5. The blower 5 has a fan wheel 6. In the preferred embodiment of the blower apparatus 1, the blower 5 is arranged in the housing base body 4. In an alternative embodiment, it can also be provided that the blower 5 is arranged outside the housing base body 4.

The blower 5 serves to generate an air flow. The air flow is generated by rotation of the fan wheel 6 and is taken in via an intake opening 28 on the housing 2, in particular on the housing base body 4. Furthermore, the rotating fan wheel 6 conveys the air flow further to an opening 29 (FIG. 5) on the housing 2, in particular on the housing base body 4. An intake grille 30 is provided as a safety guard in the intake opening 28. At the discharge opening 29 of the housing 2, the air flow proceeds in a blower tube 10 and exits into the outside environment of the blower apparatus 1 at a blower tube opening 31. The air flow then exiting the blower tube opening 31 of the blower tube 10 can then be used for blowing away foliage and the like.

As shown in FIGS. 1-3, the blower tube 10 is arranged on the housing 2, in particular on the housing base body 4 of the housing 2. For this purpose, a tube connector 9 is formed on the housing 2 (FIGS. 5 and 6), on which tube connector the blower tube 10 can be fastened. The blower tube 10 is in particular detachably fastened to the housing 2, in particular to the housing base body 4. In the preferred embodiment, the blower tube 10 is fastened to the housing base body 4 via a bayonet closure 32. Other reversible connections, which form a holding means for the blower tube 10 on the tube connector 9, can also be expedient. The blower tube 10 is preferably made of plastic. Alternative materials may also be expedient.

As shown in FIG. 2, the blower apparatus 1 includes a drive motor 3 which drives the fan wheel 6 so that it rotates about an axis of rotation 7. The drive motor 3 is illustrated merely schematically. The drive motor 3 is part of the blower 5. In the present embodiment, the blower 5 is provided as an axial blower. In an alternative embodiment of the blower apparatus 1, the blower 5 can also be configured as a radial blower. In the present case, the drive motor 3 is configured as an electric motor. In an alternative embodiment, the drive motor 3 can also be configured as an internal combustion engine. To supply the drive motor 3 with electrical energy, the blower apparatus 1 includes at least one rechargeable battery pack 33. It can also be provided that the blower apparatus 1 includes a plurality of rechargeable battery packs 33. It may also be expedient to supply the drive motor 3 with electrical energy in a different way, for example by connecting the blower apparatus 1 to an existing power grid, or to a rechargeable battery pack carried via an additional carrying device, via a cable. The housing 2 includes a rechargeable battery slot into which the rechargeable battery pack 33 can be inserted for supplying the drive motor with electrical energy.

As shown in FIGS. 1-3, the blower apparatus 1 includes an operating element 34 for controlling the drive motor 3. The user controls, in particular, the rotational speed of the drive motor 3 via the operating element 34. In the preferred embodiment, the operating element 34 is configured as an operating lever, in particular as a pivot lever. In an alternative embodiment, the operating element 34 can also be configured as a slide element, push button, knob or similar component. The operating element 34 is associated with the handle 8, that is, when gripping the handle 8 with one hand, the user can actuate the operating element 34 with the same hand. The operating element 34 is preferably arranged at least partially on the handle 8. By virtue of the association of the operating element 34 with the handle 8, the latter is configured as an operating handle.

As shown in FIGS. 2 and 3, the blower tube 10 is configured as a telescopic tube. The blower tube 10 can be extended into an extended position 12, as shown in FIG. 2. Furthermore, the blower tube 10 can be retracted into a retracted position 13, as shown in FIG. 3. The blower tube 10 includes at least two tube segments 15, 15', 15''. The at least two tube segments 15, 15', 15" can be displaced into one another. In the present, preferred embodiment of the blower tube 10, the latter includes three tube segments 15, 15', 15" which are movable relative to one another. In an alternative embodiment of the blower tube 10, it may also be provided that the blower tube 10 includes more than three tube segments 15, 15', 15". Components of the tube segments 15, 15', 15" are a proximal tube segment 15 and a distal tube segment 15". The proximal tube segment 15 is configured for arrangement on the tube connector 9, as a result of which the entire blower tube 10 is held on the housing 2, in particular on the tube connector 9 of the housing 2, via the proximal tube segment 15. The distal tube segment 15", at least in the extended position 12, is the tube segment having the blower tube opening 31. The distal tube segment 15” of the blower tube 10, at least in the extended position 12, is at a greater distance from the housing than the remaining tube segments 15, 15' of the blower apparatus 10. In the present embodiment, a center tube segment 15' is arranged between the proximal tube segment 15 and the distal tube segment 15". The tube segments 15, 15', 15" are configured to be movable relative to one another in such a way that they assume the retracted position 13 of the blower apparatus 10 when pushed together. When the tube segments 15, 15', 15" are extended, the blower apparatus 10 is in the extended position 12.

As shown in FIGS. 1-3, the blower apparatus includes a fixing device 20. The fixing device is configured to fix the tube segments 15, 15', 15" in the retracted position 13 of the blower tube 10 so that inadvertent extension of the tube segments 15, 15', 15" can be avoided. Furthermore, the fixing device 20 is configured in such a way that, in the released state, the fixing device 20 releases the tube segments 15, 15', 15", as a result of which the tube segments 15, 15', 15" can be extended. The fixing device 20 needs to be actuated for this purpose. In the actuated position of the fixing device 20, the individual tube segments 15, 15', 15" are released by the fixing device 20 or are no longer held thereby.

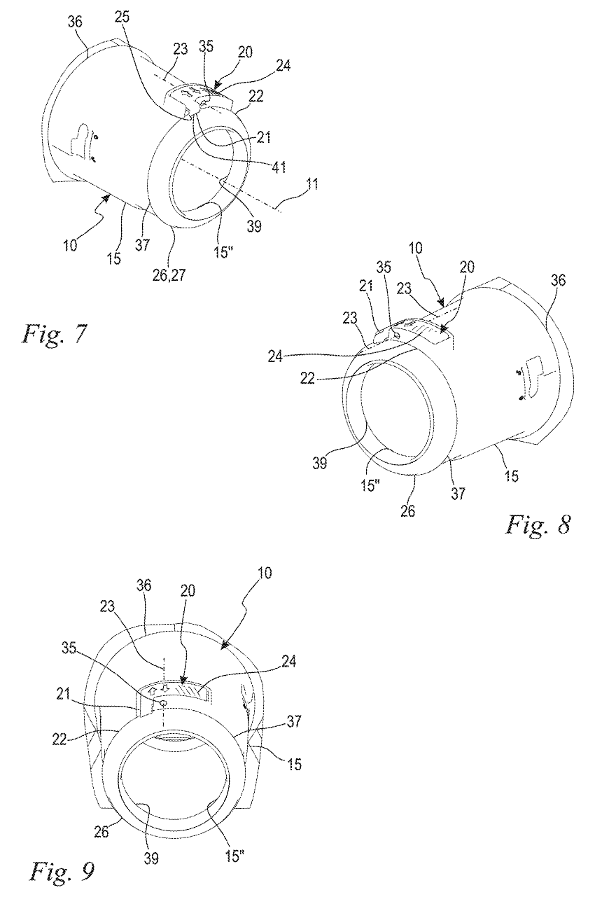

As shown in particular in FIGS. 7-9, the fixing device 20 includes a locking lever 21 and a holding contour 22 corresponding to the locking lever 21. The holding contour 22 is arranged on the distal tube segment 15''. The locking lever is particularly preferably arranged on the proximal tube segment 15. In an alternative embodiment, the locking lever 21 can also be arranged on the housing 2 of the blower apparatus 1. The locking lever 21 is mounted, in particular, so as to be pivotable about a pivot axis 23. The locking lever 21 is pivotably mounted, in particular, on a bearing pin 35. The pivot axis 23 of the locking lever 21 is preferably formed parallel to the longitudinal center axis 11 of the blower tube 10. The locking lever 21 can be pivoted into a holding position for securing the blower tube 10 in the retracted position 13 of the blower tube 10. Furthermore, the locking lever 21 can be pivoted into a release position for releasing the blower tube 10 or for extending the blower tube 10.

Furthermore, the locking lever 21 includes a spring element (not illustrated in more detail). The locking lever 21 is tensioned into the holding position by the spring element. An actuating portion 24 is formed on the locking lever 21. In order to pivot the locking lever 21 from the holding position into the release position, the user must actuate, in particular press, the actuating portion 24. In the process, the locking lever 21 pivots about the pivot axis 23 into the release position. If the user releases the actuating portion 24 again, the locking lever 21 is moved back into the holding position by the spring element. In order to press the locking lever 21 into the release position, the user must overcome the spring force coming from the spring element. The locking lever 21 is configured in such a way that it can be actuated with only one hand, in particular with only one finger. Thus, the locking lever 21 can be actuated with one hand and, at the same time, the blower tube 10 can be extended with the same hand.

The blower tube 10 is configured in particular in such a way that it can be extended by the force of the air flow. In order not to have to extend the blower tube 10 by hand, the user can actuate the locking lever 21 with one hand and the operating element 34 with the other hand. The blower 5 is activated, thereby generating the air flow. Since the tube segments 15, 15', 15" are released for extension by actuation of the locking lever 21, they are already pushed apart by the blowing force and are thus extended.

As shown in particular in FIG. 7, the locking lever 21 includes an engagement contour 41. The engagement contour 41 is approximately hook-shaped. The head of the hook-shaped engagement contour 41 is wedge-shaped and is provided for engagement in the holding contour 22. If the user actuates the locking lever 21 at the actuating portion 24, the wedge-shaped head of the engagement contour 41 is pivoted out of the holding contour 22. If the user releases the actuating portion 24, the wedge-shaped head of the engagement contour 41 is pivoted, in particular pressed, back into the holding contour 22 via the spring element.

As shown in FIGS. 7-9, the proximal tube segment 15 extends from a proximal end 36 to a distal end 37, wherein the proximal end 36 bears directly against the housing 2. The locking lever 21 is arranged at the distal end 37 of the proximal tube segment 15. In the retracted position of the blower tube 10, the holding contour 22 is arranged directly adjacent to the distal end 37 of the proximal tube segment 15. The locking lever 21 can therefore engage in the holding contour 22 in the retracted position 13 of the blower tube 10.

As shown in particular in FIG. 2, the holding contour 22 is arranged on the distal tube segment 15". The holding contour 22 is particularly preferably arranged at a distal end 39 of the distal tube segment 15". The distal end 39 of the distal tube segment 15" is a free end. The blower tube opening 31 is provided at this end. The holding contour 22 is formed by a circumferential collar 26 of a tube segment 15'', in particular the distal tube segment 15'’ in the present case. A groove is formed on the collar 26. The locking lever 21, in particular the engagement contour 41, is provided to engage in the groove of the collar 26, as a result of which the tube segments 15, 15', 15" are secured in the retracted position 13 of the blower tube 10.

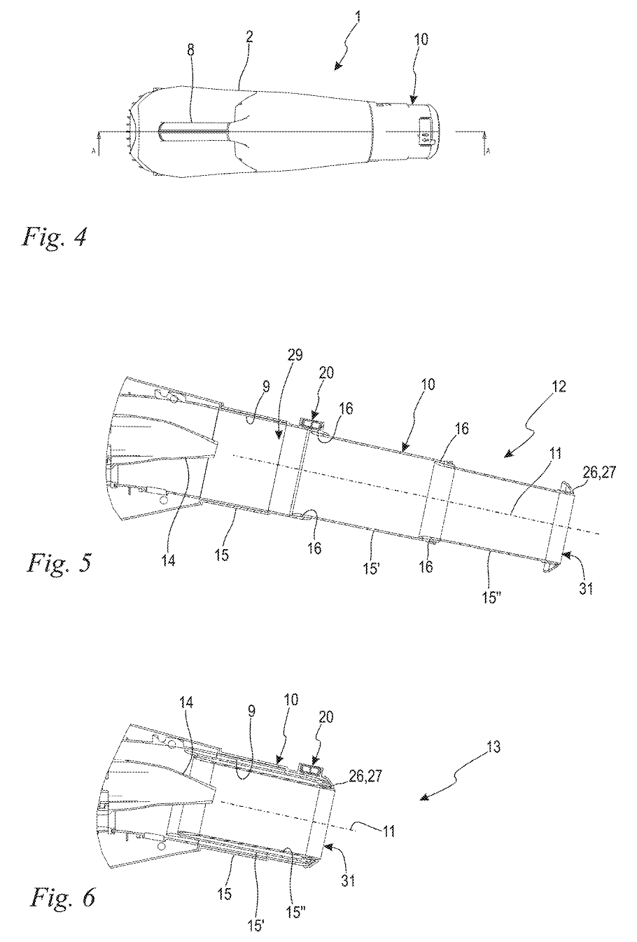

FIGS. 5 and 6 show a sectional illustration of the blower tube 10. The section shown in FIG. 6 proceeds along the section line A-A in FIG. 4. As shown in FIGS. 5 and 6, the collar 26 is formed by a mounting ring 27. The collar 26 overlaps all of the tube segments 15, 15', 15" outwardly in the radial direction relative to the longitudinal center axis 11 of the blower tube 10. The individual tube segments 15, 15' are held in the collar 26 in the retracted position 13 of the blower tube 10.

As shown in FIG. 5, the mutually corresponding ends of the individual tube segments 15, 15', 15" are configured as conical surfaces 16. When the blower tube 10 is in the extended position 12, the conical surfaces 16 of the adjacent tube segments 15, 15', 15" engage in one another and cause a clamping effect. Thus, the tube segments 15, 15', 15" are held in a mutually clamped manner by the conical surfaces 16. Inadvertent retraction of the blower tube 10 during operation of the blower apparatus 1 can thus be avoided. To retract the blower tube 10, an increased pressure on the distal tube segment 15" in the direction of the longitudinal center axis 11 towards the housing 2 is required. Furthermore, the tube segments 15, 15', 15" are held free of play by the conical surfaces 16.

As shown in particular in FIG. 2, the corresponding active surfaces 25 of the locking lever 21 and of the holding contour 22 are configured as wedge-shaped surfaces. The tube segments 15, 15', 15" are displaced in the direction of the longitudinal center axis 11. The corresponding active surfaces 25 are now configured such that they are oriented obliquely with respect to the longitudinal center axis 11. When the tube segments 15, 15', 15" are pushed together, the active surface 25 of the collar 26, which is oriented obliquely with respect to the longitudinal center axis 11, presses the active surface 25 of the locking lever 21, in particular of the engagement contour 41 of the locking lever 21, which is oriented obliquely with respect to the longitudinal center axis 11, axially outward until the collar 26 strikes the proximal tube segment 15 and the locking lever 21 latches into the holding contour 22. It is therefore not necessary to actuate the locking lever 21 by hand in order to secure the tube segments 15, 15', 15" in the retracted position 13 of the blower tube 10 via the locking lever 21.

As shown in FIGS. 2 and 3, in the fully extended position 12 of the blower tube 10, the blower apparatus 1 has a first overall length L1, measured in the direction of the longitudinal center axis 11 of the blower tube 10. In the fully retracted position 13 of the blower tube 10, the blower apparatus 1 has a second total length L2, measured in the direction of the longitudinal center axis 11 of the blower tube 10. The second overall length L2 of the blower apparatus 1 corresponds at most to 75%, in particular at most to 70%, of the first overall length L1 of the blower apparatus 1. Thus, a high telescopability of the blower tube 10 is ensured.

As shown in FIG. 6, the blower apparatus 10 includes a guide cone 14 along which the air flow flows. The blower apparatus 10 can be retracted in such a way that at least one tube segment 15, 15', 15", preferably all tube segments 15, 15', 15", overlap with the guide cone 14 in the direction of the longitudinal center axis 11 of the blower tube 10. The operation of the blower apparatus 1 is also possible in the retracted position 13, even if there are slight flow losses.

As shown in FIG. 6, in the retracted position 13 of the blower tube 10, the center tube segment 15' and the distal tube segment 15" are arranged at least partially radially inside the tube connector 9. The proximal tube segment 15 is seated on the tube connector 9. The proximal tube segment 15 is thus arranged at least partially axially outside the tube connector 9. Furthermore, the tube segments 15, 15', 15" are arranged at least partially in the housing 2, in particular in the tube connector 9 of the housing 2, in the direction of the longitudinal center axis 11 of the blower tube 10 in the retracted position 13.

It is understood that the foregoing description is that of the preferred embodiments of the invention and that various changes and modifications may be made thereto without departing from the spirit and scope of the invention as defined in the appended claims.

1. A handheld blower apparatus comprising:
a blower tube;
a housing;
a fan wheel;
a drive motor arranged in said housing, said drive motor being configured to drive said fan wheel in a rotating manner;
said fan wheel being configured to take in an air flow via an intake opening of said housing and to deliver the air flow via a discharge opening of said housing;
said blower tube being connected to said discharge opening;
said blower tube being configured as a telescopic tube with at least two tube segments including a distal tube segment; and,
a fixing device having a locking lever and a holding contour corresponding to said locking lever, wherein said holding contour is arranged at a distal end of said distal tube segment.

2. The blower apparatus of claim 1 further comprising:
a tube connector; and,
said blower tube being detachably fastened to said tube connector.

3. The blower apparatus of claim 1, wherein said fixing device is a constituent part of said blower tube and is configured for one-handed operation for retracting and extending said blower tube.

4. The blower apparatus of claim 1, wherein said blower tube includes a plurality of tube segments which are movable relative to one another; and, said locking lever is arranged on a proximal tube segment of said plurality of tube segments.

5. The blower apparatus of claim 1, wherein said locking lever is mounted so as to be pivotable about a pivot axis and is configured to be pivoted between a holding position for securing said blower tube in a retracted position and a release position for extending said blower tube.

66 The blower apparatus of claim 5, wherein said locking lever includes a spring element; and, said locking lever is tensioned into said holding position via said spring element and is configured to be pivoted into the release position in opposition to a spring force of said spring element via an actuating portion formed on said locking lever.

7. The blower apparatus of claim 1, wherein corresponding active surfaces of said locking lever and of said holding contour are arranged obliquely with respect to a movement direction of said at least two tube segments in a direction of a longitudinal center axis of said blower tube.

8. The blower apparatus of claim 1, wherein said holding contour is formed by a circumferential collar of one of said at least two tube segments.

9. The blower apparatus of claim 8, wherein said circumferential collar is formed by a mounting ring.

10. The blower apparatus of claim 1, wherein said at least two tube segments are configured to be fastened to one another via conical surfaces.

11. The blower apparatus of claim 1, wherein, in a fully extended position of said blower tube, the blower apparatus has a first overall length, measured in a direction of a longitudinal center axis of said blower tube, and, in a fully retracted position of said blower tube, a second overall length, measured in the direction of the longitudinal center axis of said blower tube; said second overall length of the blower apparatus corresponds at most to 75% of said first overall length of the blower apparatus; and, in the fully retracted position, said blower tube is secured against an extension movement by said fixing device.
